(19) United States
(12) Patent Application Publication
(10) Pub. No.: US 2009/0300133 A1
(43) Pub. Date: Dec. 3, 2009

(54) NETWORK AND METHOD FOR UPDATING A PLURALITY OF DEVICES IN SUCH A NETWORK

(76) Inventor: Dominique Basson, Peterborough (CA)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/469,986

(22) Filed: May 21, 2009

(30) Foreign Application Priority Data
May 27, 2008 (EP) 08009650.6

(51) Int. Cl. G06F 15/16; G06F 15/177

(52) U.S. Cl. 709/209; 709/221

(57) ABSTRACT

A network and a method for updating a plurality of devices in a network are described. A primary master device provides update information for slave devices. One or more first predetermined slave devices are enabled to operate in a temporary master mode. The primary master device downloads the update information to the first predetermined slave devices. The first predetermined slave devices switch, when the download is completed, into the temporary master mode for downloading the update information to second slave devices.

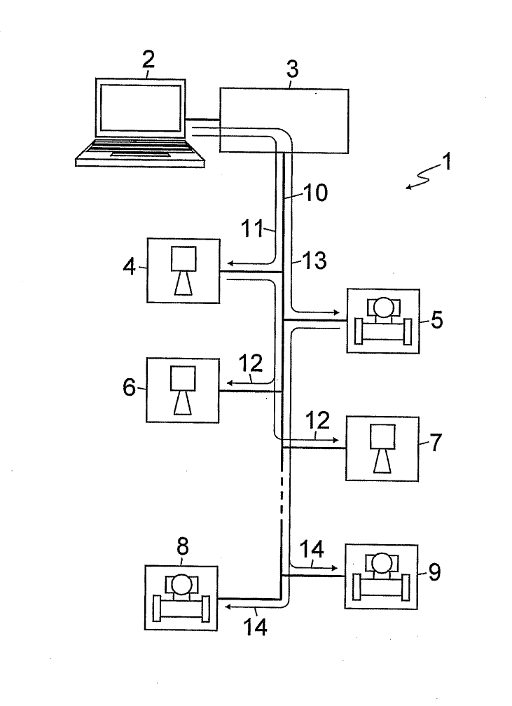

### CROSS REFERENCE TO RELATED APPLICATIONS

This application claims priority of European Patent Application No. 08009650.6 EP filed May 27, 2008, which is incorporated by reference herein in its entirety.

### FIELD OF INVENTION

The invention relates to a network comprising a plurality of devices interconnected by communication links. It further relates to a method for updating a plurality of devices in such a network.

### SUMMARY OF INVENTION

When the configuration, e.g. configuration parameters, of devices in a network, e.g. automation devices in an industrial automation system, needs to be updated, especially replicated or duplicated, it is necessary for the individual involved to perform a configuration download to each device. The greater the number of devices in the network, the greater the effort required will be.

According to the invention this problem is solved by a network and a method as claimed in the independent claims.

Preferred embodiments of the invention are defined in the dependent claims.

Thus, according to the invention,
at least one primary master device, e.g. a PLC or an industrial PC with master interface to the network, provides update information for the remaining slave devices,
one or more predetermined slave devices are enabled to operate in a temporary master mode,
the primary master device downloads the update information to the predetermined slave devices, and
the predetermined slave devices switch, when the download is completed, into the temporary master mode for downloading the update information to respective associated ones of the other slave devices.

Preferably, the predetermined slave devices are of different types and the respective other slave devices associated to a respective one of the predetermined slave devices are of the same type. For example, a predetermined level transmitter serves as the temporary master for updating the remaining level transmitters, whereas a predetermined pressure transmitter serves as the temporary master to update the remaining pressure transmitters.

The network is preferably an industrial automation system in which the slave devices are automation devices, e.g. field-mounted process devices such as transmitters and actuators, for executing predetermined functions as part of the automation system.

### BRIEF DESCRIPTION OF THE DRAWING

A preferred embodiment of the network according to the invention will be now described with reference to the single figure of the accompanying drawing.

### DETAILED DESCRIPTION OF INVENTION

The network 1, which is an industrial automation system, comprises a plurality of devices 2 to 9 interconnected by communication links 19, here mainly a bus system. The device with reference number 2 is an industrial PC which provides update information for the devices 4 to 9 and for that purpose operates as a primary master. The devices 4 to 9 are operated as slave devices under the control of device 3 which is a PLC (Programmable Logic Controller). The devices 4, 6 and 7 may be level transmitters and the devices 5, 8 and 9 may be flow transmitters. A predetermined one of the level transmitters, here device 4, and another predetermined one of the flow transmitters, here device 5, are enabled to operate in a temporary master mode.

As indicated by arrow 11, the primary master device 2 downloads update information intended for level transmitters to the predetermined slave device 4. When the download is completed, the predetermined slave device 4 switches into the temporary master mode for downloading the update information to the respective associated other slave devices 6 and 7 (arrows 12). The respective associated slave devices 6 and 7 may be defined in an address list which is part of the update information. When the replication is complete, the device 4 reverts to slave mode.

In the same way and as indicated by arrow 13 the primary master device 2 downloads update information intended for flow transmitters to the predetermined slave device 5. When the download is completed, the predetermined slave device 5 switches into the temporary master mode for downloading the update information to the respective associated other slave devices 8 and 9 (arrows 14).

1.-6. (canceled)

7. A network having a plurality of devices interconnected via communication links, comprising:
a primary master device configured to provide update information for slave devices;
first predetermined slave devices configured to operate in a temporary master mode, wherein the primary master device is further configured to download the update information to the first predetermined slave devices; and
second slave devices, wherein the first predetermined slave devices are further configured to switch, when the download of the update information to the first predetermined slave devices is completed, into the temporary master mode for downloading the update information to the second slave devices.

8. The network of claim 7, wherein the first predetermined slave devices are of different types and wherein the second slave devices associated to one type of the first predetermined slave devices are of the same type.

9. The network of claim 7, wherein the network is an industrial automation system and wherein the slave devices are automation devices for executing predetermined functions as part of the automation system.

10. The network of claim 8, wherein the network is an industrial automation system and wherein the slave devices are automation devices for executing predetermined functions as part of the automation system.

11. A method of updating a plurality of devices interconnected via communication links in a network, comprising:
providing update information for first predetermined slave devices by a primary master device;
downloading the update information to the first predetermined slave devices by the primary master device, wherein the first predetermined slave devices are enabled to operate in a temporary master mode; and
switching of the first predetermined slave devices into a temporary master mode for downloading the update information to second slave devices when the download of the updated information to the first predetermined slave devices is completed.

12. The method as claimed in claim 11, further comprising:
selecting the first predetermined slave devices, wherein each first predetermined slave device is of a different type; and
associating the second slave devices to the first predetermined slave devices, wherein second slave devices of one type are associated to the first predetermined slave device of the same type.

13. The method as claimed in claim 11, wherein the method is performed in an industrial automation system in which the slave devices are automation devices for executing predetermined functions as part of the automation system.

14. The method as claimed in claim 12, wherein the method is performed in an industrial automation system in which the slave devices are automation devices for executing predetermined functions as part of the automation system.
